(19) United States
(12) Patent Application Publication
(10) Pub. No.: US 2008/0250399 A1
(43) Pub. Date: Oct. 9, 2008

(54) Evaluation and Selection of Programming Code

(76) Inventors: Bo Huang, Shanghai (CN); Yuanhao Sun, Shanghai (CN); Lei Gao, Shanghai (CN); Jianhui Li, Shanghai (CN)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 10/580,986

(22) PCT Filed: Dec. 30, 2005
(86) PCT No.: PCT/CN2005/002384

§ 371 Date: May 25, 2006

(51) Int. Cl. G06F 9/45

(52) U.S. Cl. 717/151

(57) ABSTRACT

A system for evaluating and selecting programming code is described. A first evaluator measures a first characteristic of a number of input binaries. The evaluator computes a number of first figures of merit for the input binaries, respectively. A binary selector compares the first figures of merit, and selects one of the input binaries as having the highest or lowest overall figure of merit. Other embodiments arc also described and claimed.

An embodiment of the invention is directed to the generation and optimization of computer programming code. Other embodiments are also described.

### BACKGROUND

When an application program is launched or run in a computer, the computer is executing what is referred to as a binary image (or simply, binary) of the program. That is not, however, the version in which the program was originally created by its author. Due to the inherent design and complexity of a computer, programs are written using a higher level programming language that is more readily understandable to a human programmer. A program is initially written in what is called a source programming language (resulting in source code or a source file). It is then translated down into the binary image version (also referred to as the executable or executable file) before being loaded into the computer's memory for execution. Software programs or tools, referred to collectively here as code generators, are used by the programmer to perform this translation. A code generator is selected that is able to translate a particular source file into an executable file that is to be run on a given computer hardware platform (e.g., one that is based on a Pentium® processor by Intel Corp., Santa Clara, Calif.).

A code generator may have the following components. A compiler translates one or more input source files that are written in a high level language (e.g., C; C++; Fortran; Pascal; Basic; as well as others) into object code or object files which are in a low level language referred to as machine language. Next, a linker joins the object files, together with library object files that have been previously compiled, into a binary image (the executable file). The binary may then be loaded into the main memory of the computer and executed by one or more of its processors.

Modern integrated circuit technologies used in advanced computer components are being adopted at a rapid pace. Advances are being rapidly made in computer platform architectures, such as one based on a Pentium® processor, and new hardware components are being designed and manufactured that allow the same platform to be applied to different fields. These include, for example, personal computer (PC) desktops, laptops, home entertainment PCs, servers, home appliances, dedicated video game machines, and mobile held-held devices such as cellular telephones and multifunction personal digital assistants (PDAs). Different fields, however, present different requirements for the binaries that will be running on top of the hardware platform. For example, a program that is to run on a server is expected to have high performance while it is running, while programs that are for mobile devices may have more stringent code size as well as power consumption constraints. In other instances, a program is to be stored in non-volatile, solid state memory of the platform, which has even more stringent limits on storage space due to cost concerns. Such programs are sometimes referred to as firmware, and may need to be compressed, prior to being stored.

Current code generation tools, including compilers, linkers, and binary optimizers, provide optimization controls that can be selected by the user in an effort to generate code that has a higher performance, smaller code size, or lower power consumption. A binary optimizer, also sometimes referred to as a post-link optimizer, is a tool that is used to improve the performance of a program after it has been compiled and linked. The tool directly operates on the executable file and is thus said to rewrite the executable, in accordance with certain user specified optimization controls. Each of these tools may expose its own set of optimization controls to the user.

Current code generation tools, however, do not provide a systematic and automated approach to meet sophisticated code generation requirements. For example, the current tools do not allow the user to specify simultaneously both a code size optimization setting, i.e. one that is expected to reduce the size of the binary, and a performance optimization setting, i.e., one that is expected to increase the performance of the binary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 is a block diagram of a system for evaluating and selecting a binary based on its figure of merit, in accordance with an embodiment of the invention.

FIG. 2 is a block diagram of an example system for generating the binaries.

FIG. 3 shows another example system for generating the binaries.

FIG. 4 is a flow diagram of a methodology for generating multiple binaries and then selecting or ranking them, in accordance with their figures of merit.

FIG. 5 is a block diagram of a full featured system for code generation, evaluation, and selection, in accordance with an embodiment of the invention.

FIG. 6 is a block diagram of a computer on which a software tool, in accordance with an embodiment of the invention, can run.

### DETAILED DESCRIPTION

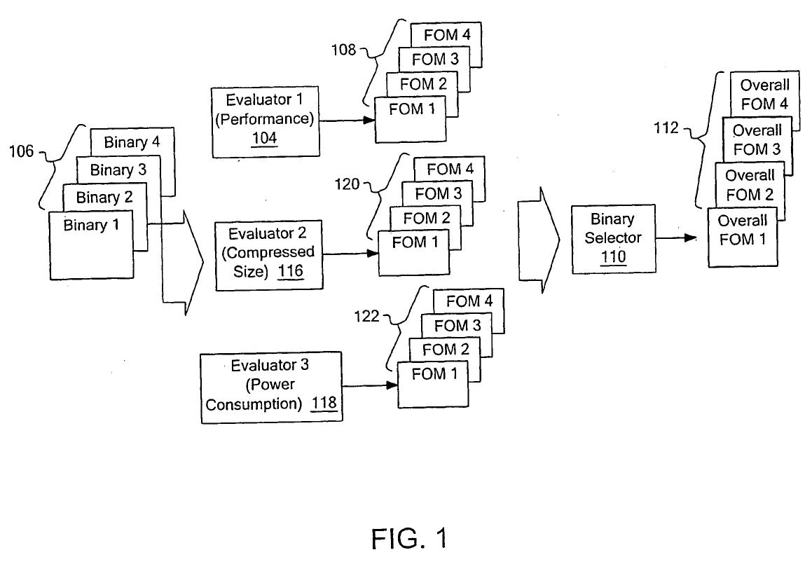

FIG. 1 is a block diagram of a system for evaluating and selecting a binary based on its figure of merit, in accordance with an embodiment of the invention. A first evaluator 104 measures a first characteristic of several input binaries 106. The evaluator 104 computes a number of first figures of merit (FOMs) 108 for the input binaries 106. In other words, FOM1 is the computed figure of merit for binary 1, FOM2 is the computed figure of merit for binary 2, etc. In this example, there are four binaries 106 illustrated, however, there may be as few as two or more than four, depending on how fine-grained the available optimization controls are. Different techniques for generating the binaries 106 will be described below.

Each of these input binaries 106 is generated with a different, code generator optimization setting, for the same processor instruction set architecture. The input binaries 106 may also be based on the same set of one or more source files (not shown). The binaries 106 may all be generated using the same code generator tool set, configured according to different optimization setting. The tool set may include components from different software vendors (e.g., a compiler and linker from one vendor, and a binary rewriter from another). Note that the input binaries 106 may be generated either manually by the user one at a time, or as described below automatically according to a script.

The evaluator 104 in this example is to measure the performance of each input binary. This may be done by having the binary be executed by a hardware platform that implements the processor instruction set architecture for which the binary has been generated. Alternatively, the evaluator 104 may include a software simulation tool, which simulates the hardware platform, including the processor and I/O device resources that are present in the actual hardware platform. The binary is thus executed on its intended hardware platform, either actually or though simulation, and its performance is measured. Performance may be measured by feeding the running binary a predefined set of inputs and measuring how fast the expected outputs are produced. The measured performance is then translated into the FOM 108. For example, faster execution of a particular task may translate to a lower FOM, while slower execution of the same task translates to a higher FOM. The “best” binary in that case would be the one with the lowest FOM 108.

The computed FOMs 108 are fed to a binary selector 110, which compares them and selects one of them as having the highest or lowest overall FOM 112. Although various ways of defining the FOMs and overall FOMs are possible, an easy to implement approach is to define each POM as being a positive integer. As a simple example, the overall FOM 112 may be the same as its corresponding FOM 108, that is,

overall FOM1=FOM1,

overall FOM2=FOM2, etc. (Equation 1)

In that case, binary selector 110 performs a straight ranking of the overall FOMs 112 and, in this example, determines that overall FOM3 (corresponding to binary 3) has the highest or lowest value. The binary selector 110 thus indicates to the user that binary 3 is the “best” of the four input binaries 106, from the standpoint of performance (being the measured characteristic). The combination of the evaluator 104 and binary selector 110 thus provide the user an automatic methodology for selecting the best binary image in a systematic manner. This general framework allows sophisticated code generation requirements to be evaluated, using multiple evaluators as described below.

FIG. 1 shows an example of a system with multiple evaluators. In addition to containing evaluator 104 described above, the system has another evaluator, evaluator 116 which measures another characteristic of the input binaries 106, namely their compressed file sizes. Each input binary 106 is compressed, and the size of the resulting compressed file is translated by the evaluator 116 to a second FOM 120. This may be performed using a conventional, software compression tool that is suitable for compressing data in the form of a binary (machine executable data). This type of evaluator 116 is useful when the code generation requirements (of a particular field of use) call for a binary that has a maximum compressed file size. For example, the binary may include a firmware driver program that is to be stored in non-volatile, solid state memory of a computer (e.g., a basic I/O system, BIOS, a boot routine, or a network management program).

The FOMs 120 are also fed to the binary selector 110 which compares the FOMs 120, while aiming at selecting the binary with the lowest or highest overall FOM. The “comparison” involving the FOMs 108 and FOMs 120 is broadly defined here, and may be implemented in several ways. As one example, an overall FOM is computed for each input binary 106, as a function of the FOM 108 and FOM 120. This may be a simple equation such as

overall FOM1=FOM1_{perf.}+FOM1_{compr.size}

overall FOM2=FOM2_{perf.}+FOM2_{compr.size} (Equation 2)

In yet another alternative, the comparison amongst the different FOMs may use the concept of a vector for each binary. For example,

overall FOM1=square_root(FOM1²_{perf.}+FOM1²_{compr.size})

overall FOM2=square_root(FOM2²_{perf.}+FOM2²_{compr.size}) (Equation 3)

If the performance FOM is defined as above, namely, the greater the performance of a binary, the smaller its associated FOM 108, then the compressed size FOM should be defined so that the smaller the compressed file size of a binary, the smaller its associated FOM 120. This approach thus defines the “best” overall FOM as the one having the lowest value.

Note that in the comparisons described above involving two measured characteristics, the equations for overall FOM weight the performance and compressed size FOMs equally. As an alternative, the equation may specify different weights to the FOMs 108 and 120. In one scenario, the performance of a binary may be less important than its compressed file size. In that case, appropriate scaling factors may be included in the equation above, to de-emphasize the contribution from the performance FOM 108, and emphasize the contribution from the compressed size FOM 120. Other ways of defining the overall FOM, including non-linear relationships with the FOMs 108, 120, are possible. The system may also give the user the option to manually define the overall FOM (a “configurable” overall FOM), e.g. in view of a particular field of use.

This methodology may be extended to more than two evaluators. For example, in FIG. 1 there is a third evaluator 118 that measures the power consumption of each binary 106, and computes a respective FOM 122 as a function of that measurement. The evaluator 118 can measure the power that is consumed by running each binary with the same task and on the same hardware platform (either in actuality or via a simulation). The FOMs 122 computed by the evaluator 118 are also fed to the binary selector 110. The binary selector 110 compares the FOMs 122, either amongst themselves or to the FOMs 108 and/or FOMs 120, to compute an overall FOM 112 for each binary (e.g., as a function of all three measured characteristics of that binary). Consistent with the definition of the overall FOM given above, the third FOM 122 may be defined such that the higher the measured power consumption, the greater the FOM 122, and the lower the measured power consumption, the lower the FOM 122. This definition is consistent with the concept of a “cost” as the FOM (described below).

In addition to performance, compressed file size, and power consumption, the measured characteristics may also include code size (the size of the binary, typically given in bytes), and its memory footprint (the size of the code and/or data portion of the binary once it is loaded and running on the intended hardware platform). Any two or more of such measured characteristics may be evaluated, by including two or more corresponding evaluators within the system. A system may be delivered that is custom designed with only two evaluators, whereas a fully featured system may have all five or more evaluators integrated in the same software tool. As yet another alternative, the system may be delivered with only a single evaluator. A system with multiple evaluators can be advantageously used for generating optimized binary images in more than one field of use.

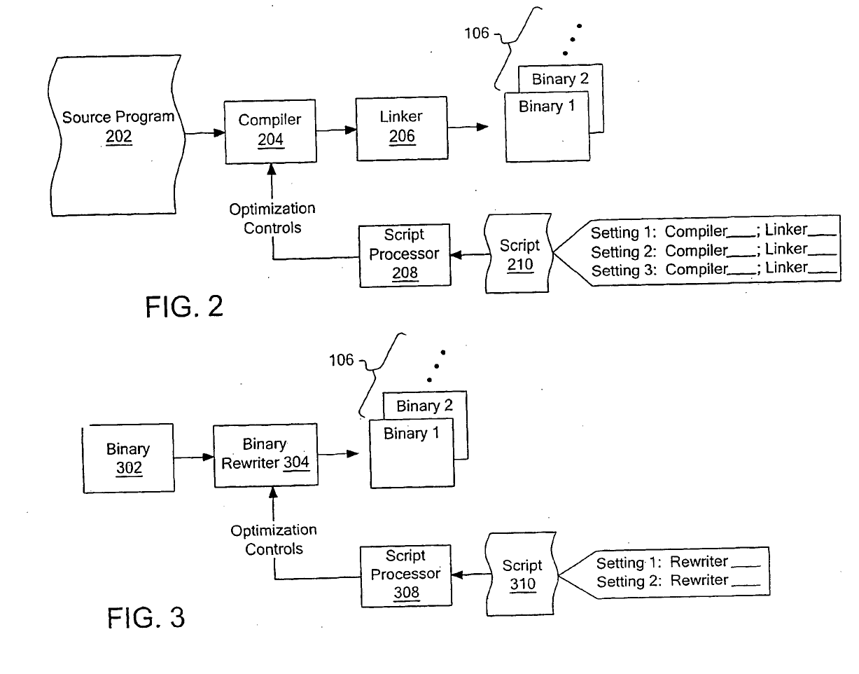

Turning now to FIG. 2, FIG. 2 is a block diagram of an example system for generating the binaries. The code generator in this instance includes a compiler 204, and a linker 206 that processes an output of the compiler to produce the input binaries 106 based on the same source program 202. The source program 202 may be in the form of one or more source files. The linker 206 links two or more object files and libraries into a resulting binary image. The compiler 204, as well as in some instances, the linker 206, exposes relatively fine-grained optimization controls to the user. As an example, such controls include the switching on or off of loop-unrolling optimization, turning on or off vectorization, and turning on or off constant propagation. Current compilers and linkers have a relatively limited number of additional optimization controls that are exposed to the user. It is expected that adding more optimization controls to such tools will further improve the resulting binary image that is selected by the processes described here.

The system in FIG. 2 also includes a script processor 208 that processes an input script 210. The script 210 may have been authored by the user, or it may have been generated automatically by another program. The script processor 208 reads two or more optimization combinations or optimization settings from the input script 210, and configures the compiler 204 (and perhaps the linker 206), in accordance with a given setting. Once configured in this way, the compiler and linker are then instructed (e.g., by the script processor 208) to produce an input binary 106, based on the source program 202 as input. The script processor 208 may then step through each subsequent optimization setting that is specified in the script 210, instructing the compiler 204 and linker 206 to produce further binaries 106 one after the other (again based on the same source program 202). The system thus automatically executes the wishes specified in the script 210, and generates a number of binaries 106 that are then evaluated by the system depicted in FIG. 1 described above.

Each optimization setting is different than another, and may be defined based on the user's knowledge of what each optimization setting is expected to accomplish in a general sense (in terms of the associated binary being more suitable for a given field of use). With the help of the evaluator and binary selector of FIG. 1, the user can in effect request optimizations that traditionally would not be allowed to be performed simultaneously by a conventional tool. For instance, there may be a combination optimization setting that specifies a compiler control that is expected to generate faster but more voluminous code, combined with a control that is expected to produce smaller code. Using the systematic approach of the evaluator and binary selector, the net effect of several of such optimization settings are evaluated and compared (through the FOM mechanism described above) to find the “best” one. This systematic process helps remove some of the guess work that may otherwise be unavoidable while trying to find the best optimization setting for a particular field of use.

Turning now of FIG. 3, another embodiment of the invention is depicted where the binaries 106 are generated by a binary rewriter 304 based on the same; “initial” binary 302. The binary rewriter 304 may be a conventional, binary rewriting tool, e.g., a static binary translator with both its input binary and its output binary targeting the same instruction set architecture. The binary rewriter 304 exposes optimization controls to the user that, in this embodiment, are received from a script processor 308 that has read the user's optimization settings specified in an input script 310. Example optimization controls for the binary rewriter 304 include constant propagation; code shrinking; and specialization. Many others are, of course, available. Each optimization setting is thus used to produce a separate one of the binaries 106, using the same binary rewriter 304 and based on the same initial binary 302.

In another embodiment of the invention, the code generator used to produce the binaries 106 may include not just the compiler 204 and linker 206, but also the binary rewriter 304 (processing an output of the linker 206). Each optimization setting in that case includes an optimization control for the compiler, another for the linker, and another for the rewriter. If the code generator exposes more fine-grained optimization controls, then this will allow more explorations of the different optimization combinations to be made, making it possible to generate even better or more optimized code as evaluated by the evaluators.

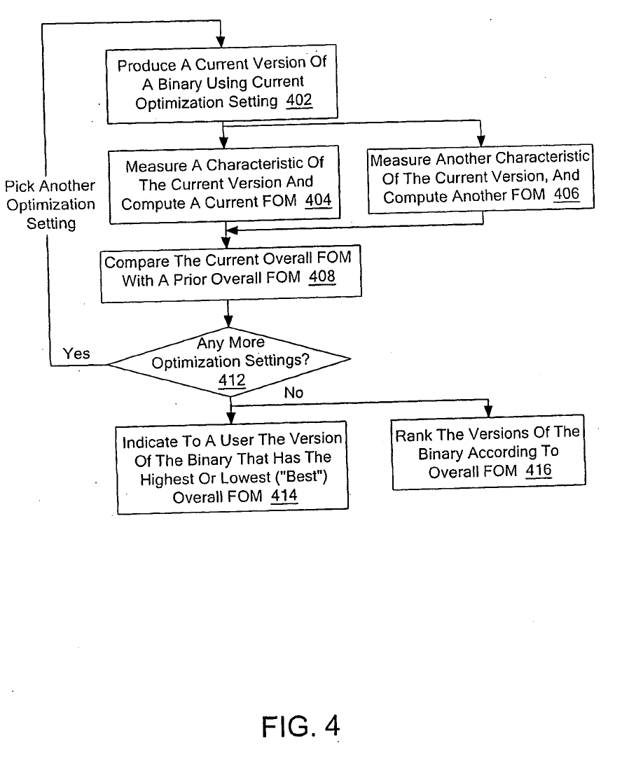

Turning now to FIG. 4, a flow diagram of an iterative process of FOM-driven code generation is shown, in accordance with an embodiment of the invention. A machine-implemented method for processing computer programming code is depicted, starting with operation 402 in which a current version of a binary is produced, using a current optimization setting. Examples of this were given above in the context of a code generator that did not have a binary rewriter (FIG. 2), as well as one in which the optimizations are performed only by a rewriter, upon the initial binary 302, without recompiling (FIG. 3). Next, a characteristic of the current version of the binary is measured, and a current FOM that is associated with that version is computed as a function of the measured characteristic (operation 404). As an example, the binary may include a firmware driver, and one of its measured characteristics is its compressed file size. The mapping between the measured characteristic and its associated FOM may vary and can be easily defined, in view of the range of the characteristic being measured (e.g., the longest and shortest run times expected for any given input binary) and a defined range for the TOM.

In operation 408, the current overall FOM is compared with a prior overall FOM. The latter is an overall FOM that may have been previously computed and that is associated with a prior version of the binary. For the initial pass, there may be no prior computed FOM, such that operation 408 may be skipped.

After the comparison in operation 408, if there are further optimization settings to be evaluated (operation 412) then the process cycles, with another optimization setting. This time, operation 408 is performed since there is a prior overall POM available now. Note that in subsequent cycles, operation 408 may involve multiple comparisons between the current overall FOM and each of several prior overall FOMs that are stored.

Once the last optimization setting has been evaluated, the loop is exited at operation 412, and the process proceeds with either operation 414 and/or operation 416. In the former, the system indicates to the user which version of the input binaries has the highest or lowest (“best”) overall FOM, as determined from the comparisons that were made in the iterative process. Note that the system may be designed such that only the binary that has the highest or lowest overall FOM value at any given point in the iterative process is saved (thereby helping conserve memory resources).

In addition to, or as an alternative to, operation 414, there is operation 416 in which the system can display to the user a ranking of the different binary versions, in accordance with their overall FOMs, e.g. from highest to lowest. This embodiment of the invention allows the user to quickly determine how “far apart” the different versions of the binaries are from each other in view of the respective optimization settings used to generate them. Other ways of displaying the results of the comparison performed by the binary selector are possible.

The flow diagram of FIG. 4 also shows operation 406 which is performed in situations where there is at least one further characteristic that is to be measured for each input binary. In that case, the FOM comparisons of operation 408 may be carried out as vector operations. For example, an overall FOM can be computed as a function of all of the FOMs for the current version, as in Equation 3 above. This value is then compared with a prior, overall FOM. The latter is computed as a function of all of the FOMs of a prior version.

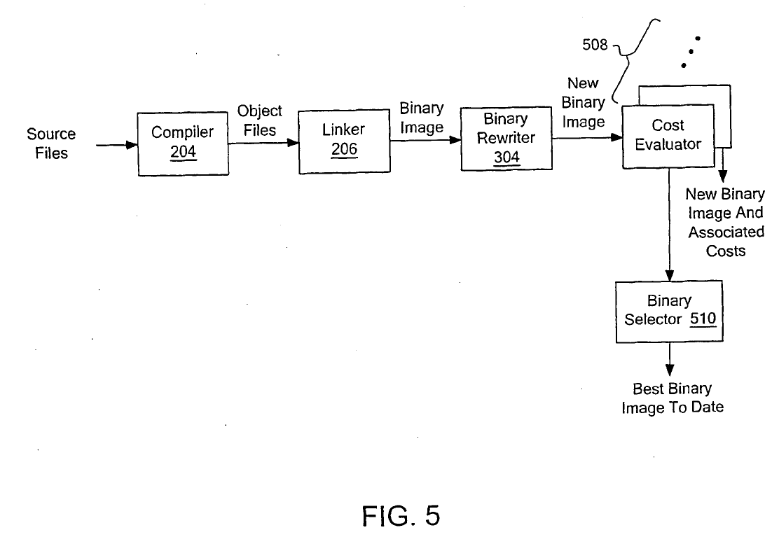

Turning now to FIG. 5, a block diagram of a full featured system for code generation, evaluation, and selection, in accordance with an embodiment of the invention is shown. In contrast to the embodiments described above in FIGS. 2 and 3, the code generator in this case includes all three code generation components, namely, compiler 204, linker 206, and binary rewriter 304. Each optimization setting in this instance may include controls for any one or all of the compiler, linker, and binary rewriter. Each new binary image at the output of binary rewriter 304 is fed to each one of a number of cost evaluators 508. The cost evaluator 508 computes a cost, as a function of a measured characteristic of the binary. Here, “cost” is not limited to a monetary amount that is to be paid or charged. Rather, it is used more generally to refer to any outlay or expenditure (as an effort or sacrifice) made to achieve an object. Alternatively, cost represents a loss or penalty that is incurred by the measured characteristic of the binary. Under this approach for the FOM, the binary that is associated with the lowest cost, or the lowest overall cost in the case where multiple factors are to be taken into consideration, becomes the best binary. This is determined by the binary selector 510 which compares the computed costs and selects the binary having the lowest overall cost. An example pseudo code that describes the framework of cost-driven code generation through an iterative exploration process (based on the concept of FIG. 5) is given below.

```
for (each optimization combination control of the compiler)
{
  Compile the source codes with the current compilation optimization
  control;
  for (each optimization combination control of the linker)
  {
    Link the program P1 using the current linking optimization control;
    for (each optimization combination control of the binary rewriter)
    {
      Rewrite the program P1 using the current optimization control
        for the binary rewriting, generate new binary image P2;
      Evaluate the cost(s) of P2;
      Perform binary selection between P2 and the old binary image
        kept in the Binary Selector;
    }
  }
}
/ /The final binary image kept in the binary selector is the best code
generated by the system
```

The above described pseudo code thus provides the most optimized (lowest cost) code, by rewriting the binary multiple times (each time using a different optimization setting) in the inner loop, and then recompiling the source program and relinking the recompiled object files (outer loop).

Integrating the compiler, linker, and the binary rewriter in the manner described above brings additional capabilities for code optimization. Also, the system flexibility of bundling together several evaluators gives the general framework the ability to take additional factors into consideration when selecting the best binary image. The system also provides a framework to better study the correlation between a particular optimization control and the cost implications that are brought as a result into the binary image.

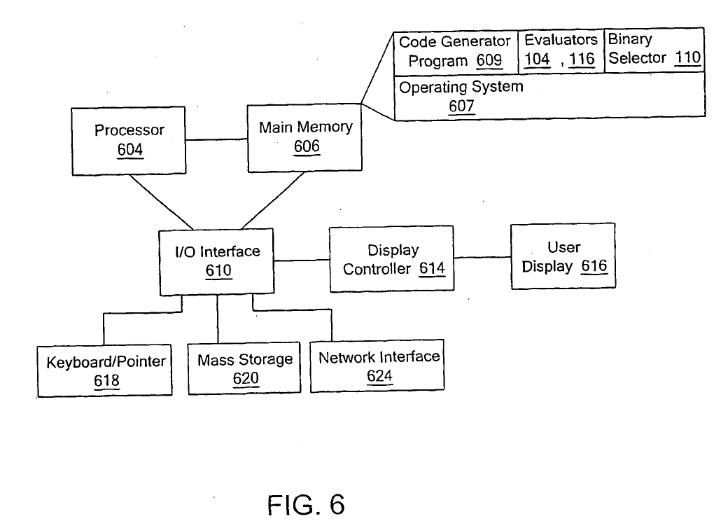

Turning now to FIG. 6, a block diagram of a computer is shown, on which a software tool, in accordance with an embodiment of the invention, can run, to perform the processes described above. The computer has a processor 604 that is an example of a machine that can execute instructions stored in main memory 606, to perform the operations described above. The main memory 606 is a machine-readable medium that has stored therein an operating system 607, and on top of which will run a code generator program 609, evaluators 104, 116, and binary selector 110. The code generator program 609 may include one or more of the code generator components described above such as a compiler, linker, and binary rewriter. These programs may also be provided in other types of machine-readable media. The results of executing programs in main memory are displayed to the user, for example, displaying ranking of a number of input binaries by the binary selector 110, on a user display 616. The processor 604 accesses the user display 616 through an I/O interface 610, and a display controller 614. As to the I/O interface 610, this allows the processor and memory to communicate with additional devices, including, for instance, a keyboard or pointer 618, a mass storage 620 (e.g., a hard disk drive), and a network interface 624 over which the computer can be used to access other nodes of a network. Other arrangements of a computer for running the different software tools described above are possible.

A machine-readable medium may include any mechanism for storing or transmitting information (such as any one or more of the software components described above) in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

The invention is not limited to the specific embodiments described above. For example, although shown to be in parallel the measurements of operations 404 and 406 may occur sequentially. In general, the order of the operations, as they are illustrated in FIG. 4 for example, may be changed in practice, depending on any given implementation of the overall process. For instance, the different versions of the binary may be produced in parallel by the same machine, using a multi-threading process. Accordingly, other embodiments are within the scope of the claims.

What is claimed is:

1. A system for evaluating and selecting programming code, comprising:
a first evaluator to measure a first characteristic of a plurality of input binaries and compute a plurality of first figures of merit for the plurality of input binaries, respectively; and
a binary selector to compare the plurality of first figure of merit and select one of the plurality of input binaries as having the highest or lowest overall figure of merit.

2. The system of claim 1 further comprising:
a second evaluator to measure a second characteristic of the plurality of input binaries and compute a plurality of second figures of merit for the plurality of input binaries, respectively, wherein
the binary selector is to compare the plurality of second figures of merit.

3. The system of claim 2 wherein the binary selector is to compute an overall figure of merit for each of the input binaries as a function of the input binary's first and second figures of merit.

4. The system of claim 2 further comprising:
a third evaluator to measure a third characteristic of the plurality of input binaries and compute a plurality of third figures of merit for the plurality of input binaries, respectively, wherein
the binary selector is to compare the plurality of third figures of merit.

5. The system of claim 2 wherein the first characteristic is performance, the greater the performance the smaller its associated figure of merit, and the second characteristic is compressed file size, the smaller the compressed file size the smaller its associated figure of merit.

6. The system of claim 2 wherein the binary selector is to compare the plurality of first and second figures of merit by computing a mathematical operation for each of the input binaries which includes the respective first and second figures of merit of that input binary.

7. The system of claim 6 wherein the first and second measured characteristics are selected from the group consisting of: performance, code size, power consumption, compressed file size, and memory footprint.

8. The system of claim 7 further comprising:
a code generator that includes a compiler and a linker to process an output of the compiler and produce the input binaries, wherein
the compiler exposes an optimization control to its user selected from the group consisting of: loop-unrolling; vectorization; and constant propagation.

9. The system of claim 8 wherein the code generator further comprises a binary rewriter to process an output of the linker and produce the input binaries, wherein the binary rewriter exposes an optimization control to its user selected from the group consisting of: constant propagation; code shrinking; and specialization.

10. The system of claim 8 further comprising:
a script processor to process an input script from the user, the script processor to read a plurality of optimization combinations from the input script and configure the code generator in accordance with the optimization combinations, wherein
the code generator is to produce the input binaries as configured by the optimization combinations, respectively.

11. The system of claim 7 further comprising:
a binary rewriter to produce the input binaries based on a source binary, wherein
the binary rewriter is to expose optimization controls to its user.

12. The system of claim 11 further comprising;
a script processor to process an input script from the user, the script processor to read a plurality of optimization combinations from the input script and configure the binary rewriter in accordance with the optimization combinations, wherein
the binary rewriter is to produce the input binaries as configured by the optimization combinations, respectively.

13. A machine-implemented method for processing computer programming code, comprising:
a) producing a current version of a binary using a current optimization setting;
b) measuring a characteristic of the current version and computing a current figure of merit (FOM) associated with the current version;
c) comparing the current FOM with a previously computed FOM associated with a prior version of the binary; and
automatically repeating a)-c) for another optimization setting.

14. The method of claim 13 further comprising:
indicating to a user the version of the binary that has the highest or lowest FOM as determined from the comparisons.

15. The method of claim 14 further comprising:
ranking a plurality of versions of the binary in accordance with their respective FOMs as determined from the comparisons.

16. The method of claim 13 wherein the current and another optimization settings include optimization controls for compilation, linking, and binary rewriting, and wherein said producing comprises:
compiling source code and linking object files to produce an initial version of the binary, and rewriting the initial version into the current version, using the current optimization setting.

17. The method of claim 13 wherein the current and another optimization settings include optimization controls for compilation and linking, and wherein said producing comprises:
compiling source code and linking object files to produce the current version of the binary, using the current optimization setting.

18. The method of claim 13 wherein the current and another optimization settings include optimization controls for binary rewriting, and wherein said producing comprises:
rewriting an initial version of the binary into the current version, using the current optimization setting.

19. The method of claim 13 further comprising:
d) measuring another characteristic of the current version and computing another figure of merit (FOM) associated with said another characteristic and the current version; and
e) comparing said another FOM with a previously computed FOM that is associated with said another characteristic and with a prior version of the binary.

20. The method of claim 13 wherein the binary comprises a firmware driver, and the characteristic is compressed file size of the binary.

21. An article of manufacture comprising:
a machine-accessible medium containing instructions that, when executed, cause a machine to:
a) generate a binary under an optimization setting;
b) compute a cost as a function of a measured characteristic of the binary;
c) perform a)-b) a plurality of times each time with a different optimization setting but based on the same source program; and
d) compare the computed costs, to select the binary having the lowest overall cost.

22. The article of manufacture of claim 21 wherein the instructions cause the machine to perform a)-b) a plurality of times, by first compiling the source program and then rewriting the binary a plurality of times and then recompiling the source program and then rewriting the recompiled binary a plurality of times.

23. The article of manufacture of claim 21 further comprising instructions that cause the machine to perform b) by computing a further cost as a function of a measured, further characteristic of the binary generated in a).

24. The article of manufacture of claim 23 wherein the instructions cause the machine to compare the computed costs in d), by computing an overall cost for each generated binary, wherein the overall cost is a function of said cost and said further cost computed in b).
